(19) United States
(12) Patent Application Publication
(10) Pub. No.: US 2001/0054488 A1
(43) Pub. Date: Dec. 27, 2001

(54) Combination rolling and non-rolling laminating tool with brake and quick-change locking mechanism

(76) Inventor: Joseph P. Tutewohl, Rockville Centre, NY (US)

Correspondence Address: Thomas M. Galgano, Esq., Galgano & Burke, Suite 135, 300 Rabro Drive, Hauppauge, NY, 11788, US

(21) Appl. No.: 09/923,523

(22) Filed: Aug. 7, 2001

Related U.S. Application Data
(63) Continuation-in-part of application No. 09/515,541, filed on Feb. 29, 2000.
Application No. 09/515,541 is a continuation of application No. 09/037,267, filed on Mar. 9, 1998, now Pat. No. 6,089,298.
Application No. 09/037,267 is a continuation of application No. 08/600,534, filed on Feb. 13, 1996, now Pat. No. 5,725,727.

(51) Int. Cl. B44C 7/02

(52) U.S. Cl. 156/579

(57) ABSTRACT

A laminating tool includes an elongated handle having a first end and an opposite second end, a freely-rotatable roller supported at the first end of the handle, and a relatively narrow wedge shaped laminate edge presser supported at the opposite second end of the handle. According to a first aspect of the invention, the handle is provided with a brake mechanism for braking the roller to prevent run-offs. The laminating tool further includes a relatively broad veneer presser which is releasably attachable to the handle via a quick-connect and quick-release structure. According to a second aspect of the invention, the veneer presser has a smooth radius tip. According to a third aspect of the invention, a quick-connect and quick-release structure includes a male locking structure on the inner end of the veneer presser arm and a female locking structure inside the handle. According to a fourth aspect of the invention, a variety of quick-connect and quick-release surface pressure tips are provided.

This application is a continuation-in-part of application Ser. No. 09/515,541 filed Jul. 13, 2000, which in turn is a continuation of Ser. No. 09/037,267 filed Mar. 9, 1998, which in turn is a continuation of Ser. No. 08/600,534 filed Feb. 13, 1996, now U.S. Pat. No. 5,725,727, the complete disclosure of which is hereby incorporated by reference herein.

### BACKGROUND OF THE INVENTION

1. Field of the Invention

The present invention relates generally to hand held laminating tools for use in applying pressure to surfaces. More particularly, this invention relates to a hand held, three-in-one combination laminating tool having a surface roller, a laminate edge presser and a veneer presser for use in applying pressure to the surface of either plastic laminates or wood veneers during bonding thereof to a suitable substrate.

2. State of the Art

Plastic laminates such as Formica® are typically bonded to a substrate such as wood in the fabrication of counter tops, table tops, doors and cabinets. The bonding process generally includes applying a layer of adhesive to the rear side of the laminate and/or applying a layer of adhesive to the substrate, and subsequently contacting and adhesively bonding the laminate and substrate together. Importantly, after contacting and bonding the laminate and substrate together, pressure is applied to the top surface of the laminate in order to form a secure adhesive bond between the laminate and the substrate. The application of pressure between the laminate and the substrate insures that the adhesive layer more completely and uniformly contacts and bonds with the laminate and substrate, as well as, aid in removing any air bubbles therebetween.

The most commonly used tools for applying pressure to a laminate surface during the bonding thereof to a suitable substrate, are configured similar to paint rollers. Specifically, such tools include a straight handle attached via a generally L-shaped arm to a freely rotatable roller having an axis disposed normally to the handle. One drawback with this type of tool is the difficulty in transferring forces from the straight handle through the roller to the laminate surface. Another drawback of this type of tool is the difficulty in applying an evenly distributed and high pressure to the laminate surface due to the generally cantilevered support of the roller by the handle. A further drawback of this type of tool is the inability to apply pressure to relatively small and tight surface areas where the roller cannot reach, such as corners, edges or butt joints.

Similarly configured rollers such as described above are disclosed in U.S. Pat. No. 3,540,104 to Duffy for a wall paper seam roller, and U.S. Pat. No. 5,242,362 to Talamantez for a lightweight floor covering roller.

Another type of laminating tool is disclosed in U.S. Pat. No. 5,068,951 to Abrams, which discloses a device for applying a constant pressure to a surface. The device includes a cylinder, a first wheel and a second wheel coupled to each end, respectively, of the cylinder, and an elastomeric covering which surrounds the cylinder. The elastomeric covering extends a greater distance than the diameter of the wheels and a straight wire-like handle attaches to both sides of the wheels. A drawback with this device is the difficulty in transferring large forces from the straight handle through the roller to the laminate surface. Another drawback with this device is the inability to apply pressure to the relatively small and tight surface areas due to the wheels and portions of the handle extending from the ends of the elastomeric covering which contacts the surface.

Another roller design for applying pressure to a laminate during the bonding thereof to a suitable substrate is shown in U.S. Pat. No. 5,069,732 granted to Levine. Levine discloses a hard-rubber roller rotatably mounted within and extending beyond one corner of a pressure block. In Levine, a heel of a user's palm is placed on top of the corner adjacent the roller and the fingers grip the opposite corner of the block. A drawback of this type of roller is the inability to apply pressure to relatively small and tight surface areas due to a user's fingers or thumb contacting adjacent structure so as to limit access of the roller to corners, edges and butt joints.

My prior U.S. Pat. No. 5,725,727 discloses a combination laminating tool which includes an elongated handle having a first end and an opposite second end, a freely-rotatable roller supported at the first end of the handle, and a relatively narrow wedge shaped laminate edge presser supported at the opposite second end of the handle. A generally U-shaped yoke is joined to the first end of the roller and the yoke includes a pair of spaced-apart arms for rotatably supporting the roller therebetween.

In a preferred embodiment, the laminating tool of the '727 patent further includes a relatively broad wedge shaped veneer presser which is releasably attachable to the handle. Specifically, the veneer presser has a generally T-shaped profile and includes an arm and an enlarged outwardly flared broad wedge secured to the arm. The arm has an inner end which is releasably and telescopically received within the opposite second end of the handle, and an opposite outer end which attached to the wedge. The tool further includes releasable locking means for releasably locking the veneer presser on the handle. The releasable locking means consist of an outwardly biased button disposed on the arm of the veneer presser so that the button is receivable in a snap-fit manner in a corresponding button opening in the handle. The veneer presser is released from the handle by pressing the button while pulling the handle and veneer presser apart.

One of the issues not addressed by my earlier patent is that of “laminate run-off”. It will be appreciated that during lamination, the laminate material is larger than the surface to which it is being laminated. After lamination is complete, the laminate material is trimmed to the size of the surface. A laminate run-off is when a surface roller slips off the overhanging surface of a laminate material, thus cracking the finish surface. In order to fix this, the laminate material must be removed by delaminating it with thinners. The removed material is scrapped. All glue and thinners must then be removed from the surface which was intended to be laminated and the surface must dry for thirty minutes or more before starting the laminating process over again with a newly cut piece of laminate material.

I have also discovered that the wedge shaped veneer presser and edge presser of my prior invention are not necessarily ideal for all veneer pressing operations. Moreover, I have discovered an improved releasable locking means.

### SUMMARY OF THE INVENTION

Accordingly, it is an object of the present invention to provide a novel combination laminating tool which is conveniently held with one hand so that a user can easily alternate between use of a freely-rotatable roller and relatively narrow blade-like laminate edge presser for applying pressure to essentially the entire surface of a laminate such as Formica® during the bonding thereof to suitable substrate.

It is another object of the present invention to provide a combination laminating tool having a freely-rotatable roller supported by the arms of a U-shaped yoke member attached to one end of an elongate handle which allows a user to quickly apply an evenly distributed high pressure to those large easily accessible surface areas of a laminate during the bonding thereof to a suitable substrate.

It is also an object of the present invention to provide a combination laminating tool having a relatively narrow wedge shaped laminate edge presser attached to the opposite end of an elongate handle which allows a user to quickly apply pressure to typically inaccessible laminate surface areas, e.g., edges, corners and butt joints.

It is still another object of the present invention is to provide a combination laminating tool which includes a relatively broad veneer presser for applying the appropriate pressure to delicate and relatively thin and easily damaged veneers.

It is yet another object of the invention to provide a laminating tool having means for preventing laminate run-off.

It is still another object of the invention to provide a laminating tool having a quick-connect and quick-release veneer pressor.

It is yet another object of the invention to provide a laminating tool kit having a variety of quick-connect and quick-release veneer/edge pressers/smoothers with different end shapes.

In accord with these objects which will be discussed in detail below, the laminating tool of the present invention includes an elongated handle having a first end and an opposite second end, a freely-rotatable roller supported at the first end of the handle, and a relatively narrow wedge shaped laminate edge presser supported at the opposite second end of the handle. Preferably, a generally U-shaped yoke is joined to the first end of the roller and the yoke includes a pair of spaced-apart arms for rotatably supporting the roller therebetween. According to a first aspect of the invention, the handle is provided with a brake mechanism for braking the roller to prevent run-offs.

The laminating tool further includes a relatively broad veneer presser which is releasably attachable to the handle via a quick-connect and quick-release structure. Specifically, the veneer presser has a generally T-shaped profile and includes an arm and an enlarged outwardly flared broad working end secured to the arm. The arm has an inner end which is releasably and telescopically received within the opposite second end of the handle. According to a second aspect of the invention, the veneer presser has a smooth radius tip rather than a wedge shape. The radius tip relieves body strain and provides the operator with a quicker, more efficient tool in smoothing and removing air pockets beneath laminates materials such as wallpaper, wood veneer, vinyl flooring, contact paper, etc.

According to a third aspect of the invention, a quick-connect and quick-release structure includes a male locking structure on the inner end of the veneer presser arm and a female locking structure inside the handle. The quick-connect and quick-release structure allows removal of the veneer presser without the need to push any buttons.

According to a fourth aspect of the invention, a variety of quick-connect and quick-release surface pressure tips are provided, e.g. 45°, 60°, 90°, 180°, ¼ round and ½ round). The pressure tips are connected to the handle in the same manner as the veneer presser and are used for tight inaccessible areas and all areas where surface rollers just cannot reach or properly apply pressure to the laminate material.

Preferably, the working end of the veneer presser and the handle are disposed at an angle of about 120 degrees to about 150 degrees therebetween when attached to each other, and desirably at an angle of about 135 degrees therebetween. Desirably, the handle, the laminate edge pressers and the veneer presser are fabricated from non-scratch materials.

The handle of the tool is generally cylindrical and is covered along most of its length with a cushioned grip. Preferably, the yoke and the handle are disposed at an angle of about 120 degrees to about 150 degrees therebetween, and desirably, at an angle of about 135 degrees therebetween.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of a novel laminating combination tool for laminates and wallpaper embodying the present invention;

FIG. 2A is a longitudinal sectional view of the laminating tool of the invention with the veneer presser attached;

FIG. 2B is a longitudinal sectional view of the laminating tool of the invention showing the brake mechanism in a braking position.

FIG. 3 is a top plan view of the laminating tool with the veneer presser removed;

FIG. 3 is a bottom plan view of the veneer presser;

FIG. 4 is a sectional view taken along line 4-4 in FIG. 3; and

FIGS. 6-11 are enlarged sectional views of differently shaped surface pressure tips according to the invention.

### DETAILED DESCRIPTION OF THE PREFERRED EMBODIMENTS

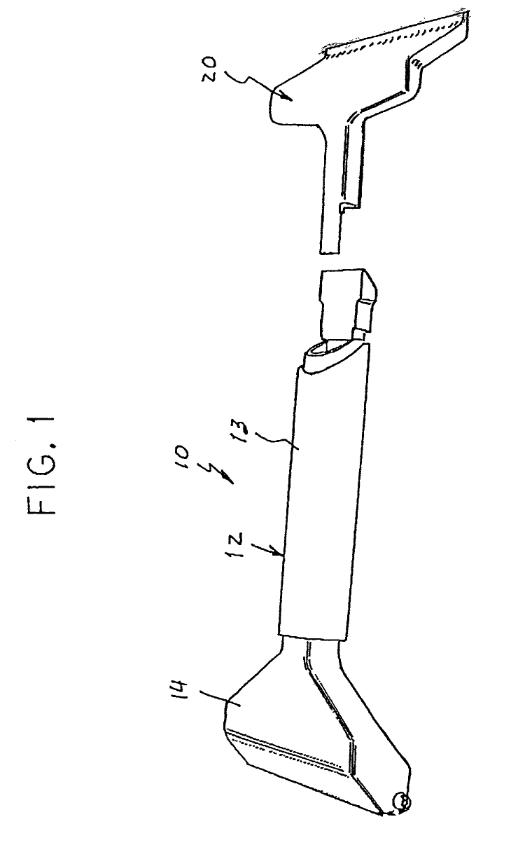

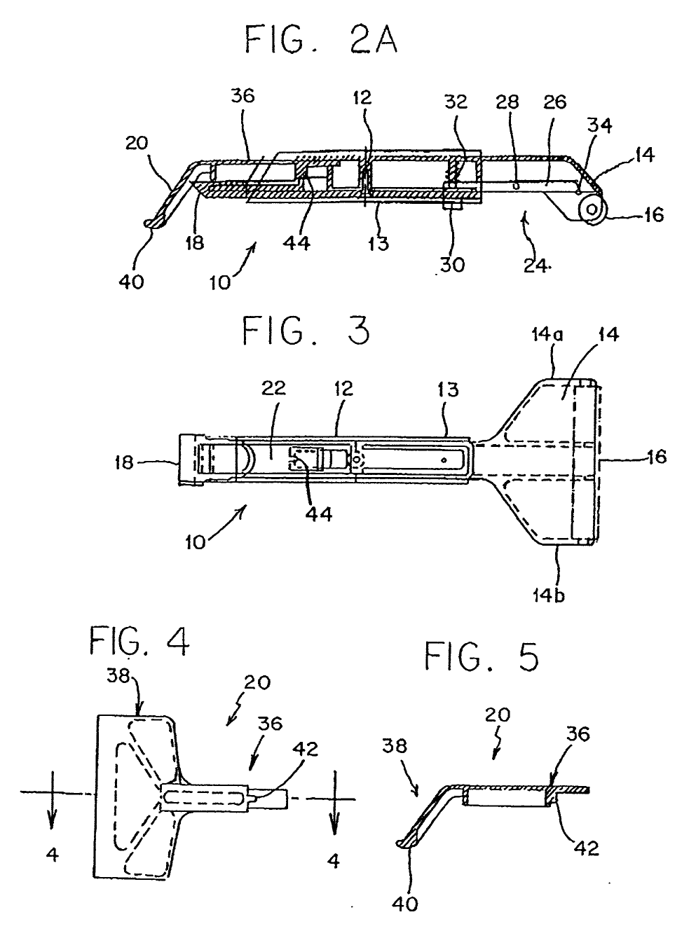

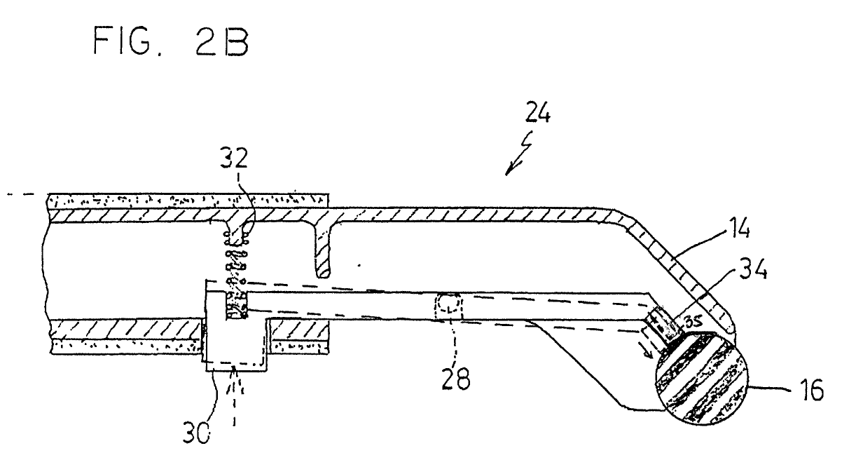

Referring now to FIGS. 1 and 2, a three-in-one combination laminating tool 10 according to the invention which is made of plastic and which includes an elongated generally cylindrical shaft or handle 12 which has an enlarged, generally U-shaped yoke 14 disposed at one end thereof which supports a freely-rotatable roller 16 between spaced apart arms 14a, 14b. The handle 12 is preferably covered with a cushioned grip 13 along most of its length. A relatively narrow wedge shaped laminate edge presser 18 is supported at an opposite second end of the handle 12. As shown in FIG. 2A, a relatively broad veneer presser 20 is telescopically mounted in a hollow recess 22 of the handle 12. The veneer presser preferably has a width equal to or greater than the roller 16.

According to a first aspect of the invention, the handle 12 is provided with a brake mechanism 24 for braking the roller to prevent run-offs. The brake mechanism 24 includes a pivot arm 26 mounted on a pivot 28 in the handle 12. One end of the pivot arm 26 has a button 30 which is biased by a spring 32 to extend out of the handle 12. The other end of the pivot arm has an engaging end 34. As can be seen in FIG. 2B, when the button 30 is depressed against the spring 32, the engaging end 34 will contact the roller 16 and frictionally engage it. Preferably, end 34 is provided with a removable plastic cap 35 which can be replaced upon wear. Using the brake mechanism, an operator can either slow down or even stop the surface roller 16 in a split second by squeezing the button 30. This feature virtually eliminates run-offs and its costly effects of double labor and material, thereby increasing productivity and profits, and greatly enhancing the quality of workmanship for both the professional and amateur craftsman.

Referring now to FIGS. 1-4, the veneer presser 20 is releasably attachable to the handle 12 via a quick-connect and quick-release structure. Specifically, as seen best in FIG. 4, the veneer presser 20 has a generally T-shaped profile and includes an arm 36 and an enlarged outwardly flared broad working end 38 secured to the arm. The arm 36 has an inner end which is releasably and telescopically received within the opposite second end of the handle 12 as shown in FIG. 2A. According to a second aspect of the invention, the veneer presser 20 has a smooth radius tip as seen best in FIGS. 2A and 5. The radius tip 40 relieves body strain and provides the operator with a quicker, more efficient tool in smoothing and removing air pockets beneath laminates materials such as wallpaper, wood veneer, vinyl flooring, contact paper, etc.

According to a third aspect of the invention, a quick-connect and quick-release structure includes a male locking structure 42 on the inner end of the veneer presser arm 36 in the form of a c-shaped finger and a female locking structure 44 inside the handle 12 in the form of a c-shaped channel which are capable of a releasable snap-fit engagement with one another. The quick-connect and quick-release structure allows removal of the veneer presser without the need to push any buttons.

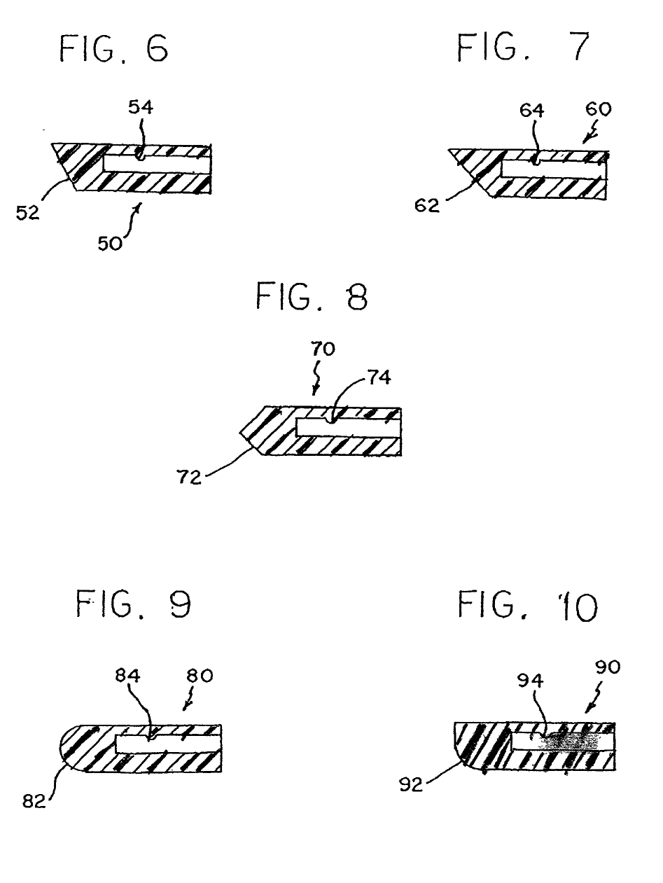

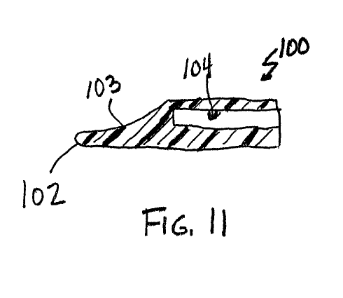

Referring now to FIGS. 6-11, according to a fourth aspect of the invention, a variety of quick-connect and quick-release surface pressure tips are provided. For example, FIG. 6 illustrates a pressure tip 50 having a 60° wedge tip 52 and a male locking structure 54 (e.g., a semispherical bead) for releasably mating with the female locking structure (e.g., a corresponding semispherical dimple) in the handle 12 in a releasable snap-fit manner. FIG. 7 illustrates a pressure tip 60 having a 45° wedge tip 62 and a male locking structure 64. FIG. 8 illustrates a pressure tip 70 having a 90° wedge tip 72 and a male locking structure 74. FIG. 9 illustrates a pressure tip 80 having a full round tip 82 and a male locking structure 84. FIG. 10 illustrates a pressure tip 90 having a quarter round tip 92 and a male locking structure 94. FIG. 11 illustrates a pressure tip 100 having a narrow rounded tip 102 having a concave-sloped upper surface 103 for working with narrow clearances and a male locking structure 104 The pressure tips are connected to the handle in the same releasable, snap-fit manner as the veneer presser and are used for tight inaccessible areas and all areas where surface rollers just cannot reach or properly apply pressure to the laminate material.

As seen best in FIG. 2A, the working end 38 of the veneer presser 20 and the handle 12 are preferably disposed at an angle of about 120 degrees to about 150 degrees therebetween when attached to each other, and desirably at an angle of about 135 degrees therebetween. The yoke 14 and the handle 12 are preferably disposed at an angle of about 120 degrees to about 150 degrees therebetween, and desirably, at an angle of about 135 degrees therebetween. Desirably, the handle, the laminate edge pressers and the veneer presser are fabricated from non-scratch materials.

There have been described and illustrated herein a combination rolling and non-rolling laminating tool with brake and quick-change locking mechanism. While particular embodiments of the invention have been described, it is not intended that the invention be limited thereto, as it is intended that the invention be as broad in scope as the art will allow and that the specification be read likewise. Thus, while the quick change locking mechanism has been disclosed as having a male component on the veneer presser and a female component on the handle, it will be appreciated that the location of the male and female components could be reversed. Also, while a variety of differently shaped pressure tips have been shown, it will be recognized that other shapes could also be provided. It will therefore be appreciated by those skilled in the art that yet other modifications could be made to the provided invention without deviating from its spirit and scope as so claimed.

1. A combination laminating tool, comprising:
an elongated handle having a first end and an opposite second end;
a freely-rotatable roller supported at said first end of said handle; and
braking means coupled to said handle for selectively braking rotation of said freely-rotatable roller.

2. A tool according to claim 1, further comprising:
a wedge shaped edge presser supported by and extending from said opposite second end of said handle.

3. A tool according to claim 1, further comprising:
a detachable veneer presser; and
means for releasably attaching said veneer presser to said opposite second end of said handle.

4. A tool according to claim 3, wherein:
said means for releasably attaching include male and female interlocking means which do not require pressing a button for release.

5. A tool according to claim 3, wherein:
said veneer presser is approximately as wide as said roller and has a rounded working surface.

6. A tool according to claim 1, further comprising:
a plurality of detachable pressure tips, each having a different shape, and each being releasably attachable to said opposite second end of said handle.

7. A combination laminating tool, comprising:
an elongated handle having a first end and an opposite second end;
a freely-rotatable roller supported at said first end of said handle; and
a plurality of detachable pressure tips, each having a different shape, and each being releasably attachable to said opposite second end of said handle.

8. A tool according to claim 7, further comprising:
a wedge shaped edge presser supported by and extending from said opposite second end of said handle.

9. A tool according to claim 7, further comprising:
a detachable veneer presser; and
means for releasably attaching said veneer presser to said opposite second end of said handle.

10. A tool according to claim 9, wherein:
said means for releasably attaching include male and female interlocking means which do not require pressing a button for release.

11. A tool according to claim 9, wherein:
said veneer presser is approximately as wide as said roller and has a rounded working surface.

12. A combination laminating tool, comprising:
an elongated handle having a first end and an opposite second end;
a freely-rotatable roller supported at said first end of said handle;
a detachable veneer presser; and
means for releasably attaching said veneer presser to said opposite second end of said handle, wherein:
said means for releasably attaching include male and female interlocking means which do not require pressing a button for release.

13. A tool according to claim 12, further comprising:
a wedge shaped edge presser supported by and extending from said opposite second end of said handle.

14. A tool according to claim 12, wherein:
said veneer presser is approximately as wide as said roller and has a rounded working surface.

15. A combination laminating tool, comprising:
an elongated handle having a first end and an opposite second end;
a freely-rotatable roller supported at said first end of said handle;
a detachable veneer presser; and
means for releasably attaching said veneer presser to said opposite second end of said handle, wherein:
said veneer presser is approximately as wide as said roller and has a rounded working surface.

16. A tool according to claim 15, further comprising:
a wedge shaped edge presser supported by and extending from said opposite second end of said handle.

17. A tool according to claim 15, wherein:
said veneer presser is approximately as wide as said roller and has a rounded working surface.
